(19) United States
(12) Patent Application Publication
(10) Pub. No.: US 2006/0287969 A1
(43) Pub. Date: Dec. 21, 2006

(54) Methods of processing biological data

(75) Inventor: Jinyan Li, Singapore (SG)

Correspondence Address: FOLEY AND LARDNER LLP;SUITE 500, 3000 K STREET NW, WASHINGTON, DC, 20007, US

(73) Assignee: AGENCY FOR SCIENCE, TECHNOLOGY AND RESEARCH

(21) Appl. No.: 10/570,330

(22) PCT Filed: Sep. 6, 2004
(86) PCT No.: PCT/AU04/01199

§ 371 Date: Aug. 2, 2006

(30) Foreign Application Priority Data
Sep. 5, 2003 (AU) 20033904855

(51) Int. Cl. G06F 15/00

(52) U.S. Cl. 706/16; 702/19

(57) ABSTRACT

The present invention relates to methods useful for processing large amounts of high-dimensional biological data, such as that provided by microarray analysis of gene expression. The methods are useful for providing rules applicable to the classification, diagnosis and prognosis of diseases such as cancer. The inventive methods implement iterative decision trees to process the training data and generate the rules. However, unlike the prior art methods the methods described avoid the use of bootstrap data and considers substantially the entire training data set at each iteration of the decision tree generation process.

### FIELD OF THE INVENTION

The present invention relates to the field of data processing. More specifically the present invention relates to methods useful for processing large amounts of high-dimension biological data, such as that provided by microarray analysis of gene expression. The methods are useful for providing rules applicable to the classification, diagnosis and prognosis of diseases such as cancer.

### BACKGROUND TO THE INVENTION

In recent years, advances in the fields of genomics and proteomics have lead to vast increases in information available to researchers in the biological sciences. Methods such as microarray gene expression profiling are capable of screening large numbers of biological samples very quickly. While this data is undoubtedly useful, the limiting step now is to convert the raw data into useable information.

Decision trees are a well known tool for extracting meaningful information from raw data. Decision trees represent a learned function for classification of discrete-valued target functions. Each internal node in a decision tree represents a test of some type and each branch corresponds to a particular value for the attribute that is represented by the node from which the branch descends. Decision trees classify novel items by traversing the tree from the root down to a leaf node, which assigns a classification to the item. Note that a decision tree can also be thought of as an if-thenelse rule: each decision tree can be viewed as a disjunction of each of the paths through a decision tree, where each path corresponds to a conjunction of properties that must hold for the attribute values of individual instances.

Decision trees are particularly suited to classification tasks in which items can be described by attribute-value pairs, the target function is discrete valued and the training data may contain noise in the training data labels or in the attribute values. Clearly, the problem of diagnosis using gene expression data fits these characteristics—each sample can be described by the expression levels (values) of a number of genes (attributes), the aim is to classify samples as belonging to one of a discrete number of classes (the leukaemias AML or ALL for example).

An example of the use of decision trees is in the classification of human tumors. This has been traditionally done on the basis of clinical, pathohistological, immunohistochemical and cytogenetic data. This classification technique provides classes containing tumors that show similarities but differ strongly in important aspects, e.g. clinical course, treatment response, or survival. Techniques using cDNA microarrays have opened the way to a more accurate stratification of patients with respect to treatment response or survival prognosis, however, reports of correlation between clinical parameters and patient specific gene expression patterns have been extremely rare. One of the reasons is that the adaptation of machine learning approaches to pattern classification, rule induction and detection of internal dependencies within large scale gene expression data is still a formidable challenge for the computer science community.

Decision trees can be constructed and rules obtained from software implemented methods such as CART and C4.5. C4.5 (Quinlan, J. R. (1993). C4.5: Programs for machine learning. San Mateo, CA: Morgan Kaufmann) is a heuristic algorithm for inducing decision trees. C4.5 uses an entropy-based selection measure to determine which feature is most discriminatory. This measure is also called gain ratio, or maximum information gain. Most decision trees in the literature are constructed by C4.5.

The construction of a decision tree is a recursive process. A typical process involves determining a feature that is most discriminatory and then splitting training data into groups. Each group can contain multi-class samples or single-class samples, as categorized by this feature. A significant feature of each group is next chosen to further partition the multi-class subsets (groups), and the process is repeated recursively until all the subsets contain single-class samples.

Committee decision techniques such as AdaBoost (Freund, Y., & Shapire, R. E. (1996). Machine Learning: Proceedings of the thirteenth National Conference (pp. 148-156)) and Bagging (Breiman, L (1996). Machine Learning, 24, 123-140) have also been proposed to reduce the errors of single trees by voting the member decisions of the committee (Friedman, J. H., Kohavi, R., & Yun, Y (1996). Proceedings of the Thirteenth National Conference on Artificial Intelligence, AAAI96 (pp. 717-724). Portland, Oreg.: AAAI Press) (Quinlan, R. J. (1996). Proceedings of the Thirteenth National Conference on Artificial Intelligence, AAAI96 (pp. 725-730). Portland, Oreg.: AAAI Press). Unlike applicant's approach, AdaBoost and Bagging both apply a base classifier (e.g., C4.5) multiple times to generate a committee of classifiers using bootstrapped training data. Assume that a given set of training data has N samples, and a number R of repetitions or trials of the base classifier is to be applied. By the bagging idea, for each trial t=1, 2 . . . , R, a bootstrapped training set is generated from the original data. Although this new training set is the same size as the original data, some samples may no longer appear in the new set while others may appear more than once. Denote the B bootstrapped training sets as . B₁, B₂, . . . Bᵣ. For each .B*, a classifier Cₜ is built. A final, bagged classifier C* is constructed by aggregating C₁, C₂, . . . , and C_{R}. The output of C* is the class predicted most often by its sub-classifiers, with ties broken arbitrarily.

Similar to bagging, boosting also uses a committee of classifiers for classification by voting. Here, the construction of the committee of classifiers is different: while bagging builds the individual classifiers separately boosting builds them sequentially such that each new classifier is influenced by the performance of those built previously. In this way those samples incorrectly classified by previous models can be emphasized in the new model, with an aim to mold the new model to become an expert for classifying difficult tasks. A further difference between the two committee techniques is that boosting weights the individual classifiers' output depending on their performance, while bagging gives equal weights to all the committee members. AdaBoost. (Freund, Y., & Shapire, R. E. (1996). Machine Learning: Proceedings of the thirteenth National Conference (pp. 148-156)) provides a good example of the boosting concept.

Emerging patterns (Dong, G & Li, J (1999). Proceedings of the Fifith ACM SIGKDD International Conference on Knowledge Discovery and Data Mining (pp. 43-52). San Diego, Calif.: ACM Press) have been shown to be an important concept for discovering significant rules from bio-medical data (Li, J & Wong L. (2002). Bioinformatics, 18, 725-734). (Li et al., (2003); Bioinformatics, 19, 71-78). However, due to the inherent complexity of the patterns, mining algorithms of emerging patterns may not be sufficiently efficient when applied to high-dimension data (e.g. data dimension of greater than 100).

A problem of these prior art methods is that they often return unjustified predictions. It is an aspect of the present invention to overcome or alleviate a problem of the prior art by providing a method of providing relatively simple and accurate rules in the characterisation, prognosis and diagnosis of disease.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of this application.

### BRIEF DESCRIPTION OF THE FIGURES

FIG. 1 shows various ranking positions of the three features used in a significant rule discovered from a prostate disease gene expression profiling data. Here S-to-N stands for the signal-to-noise measurement.

FIG. 2 shows two trees induced from the prostate disease data set of gene expression profiles of 102 cells: (a) the standard C4.5 tree constructed by using whole feature set; (b) a tree constructed by using only three top-ranked features.

FIG. 3 shows five rules in a C4.5 tree derived from a prostate disease gene expression profiling data.

FIG. 4 shows applicant's rules in a C4.5 tree built on only three top-ranked features.

FIG. 5. shows a decision tree induced by C4.5 from a layered data set to differentiate the subtype Hyperdip>50 against other subtypes of childhood leukemia. Here Hr50=Hyperdip>50, a=16115.4, b=4477.9, c=3453.4, d=2400.9.

FIG. 6 shows the error numbers (Cancer: Normal) of 10-fold cross validation by four classification models over 253 proteomic ovarian data samples.

FIG. 7 shows test error numbers of four models on the 112 independent test samples in the problem of 6-subtype classification of the ALL disease (Yeoh, E-J., et al. (2002). Cancer Cell 1, 133-143.)

FIG. 8. shows 10-fold cross validation results in the problem of subtype classification of the ALL disease.

FIG. 9. shows the test error numbers (MPM:ADCA) by four classification models over independent 149 MPM and ADCA tissue samples.

FIG. 10. shows the test error numbers by four classification models on two small data sets.

### SUMMARY OF THE INVENTION

In a first aspect the present invention provides a method of identifying a rule useful in the analysis of biological data, the method comprising the steps of

providing a training dataset having a plurality of features, and

generating a decision tree using the dataset,

wherein the training dataset remains substantially unchanged through the iterative construction of the decision tree.

In a second aspect the present invention provides a method of identifying two or more rules useful in analysis of biological data, the method comprising the steps of

providing a training dataset having a plurality of features,

generating a first decision tree having one feature of the dataset as the root node,

obtaining one or more rules from the first decision tree,

generating one or more further decision trees having a feature of the dataset not previously used in other decision trees as the root node, and

obtaining one or more further rules from each one or more further decision trees wherein the training dataset remains substantially unchanged through the iterative construction of the decision tree.

Preferably each of the two or more decision trees consider substantially the same features in the dataset. In an alternative form, the two or more decision trees consider substantially the same number of features in the dataset.

In another aspect the present invention provides a computer executable program embodying the methods of the present invention.

In another aspect the present invention also provides a computer including a computer executable program described herein.

In another aspect the present invention provides a rule or set of rules produced according to a method described herein.

In a further aspect the present invention provides a method of classifying, characterising, diagnosing or prognosing a disease in a patient comprising a method described herein.

Throughout the description and claims of this specification, the word “comprise” and variations of the word, such as “comprising” and “comprises”, is not intended to exclude other additives, components, integers or steps.

### DETAILED DESCRIPTION OF THE INVENTION

In a first aspect the present invention provides a method of identifying a rule useful in the analysis of biological data, the method comprising the steps of

providing a training dataset having a plurality of features, and

generating a decision tree using the dataset,

wherein the training dataset remains substantially unchanged through the iterative construction of the decision tree.

Applicants have shown that the method described herein provides highly competitive accuracy compared to C4.5, bagging, boosting, SVM, and k-NN. The methods also provide easily comprehensible rules that help in translating raw data into knowledge.

Applicant's method differs from prior art committee classifiers in the management of the original training data. Bagging and boosting generate bootstrapped training data for every iteration's construction of trees. In a preferred form the applicant's method keeps the size of the original data and/or the features' values substantially unchanged throughout the whole process of generating the decision tree. As a result, applicant's rules will more precisely reflect the nature of the original data, whereas because of the use of bootstrapped training data, some bagging or boosting rules may not be true when applied to the original training data.

As used herein, an example of a rule is a set of conditions with a predictive term. In a preferred embodiment of the invention the conditions are conjunctive conditions. An example of a generally preferred form of a rule relevant to the present invention is represented as follows:
If cond₁ and cond₂ and . . . condₘ,
then a predictive term

The predictive term in a rule often refers to a single class (e.g., a particular subtype of a cancer). In one form of the invention all conditions in a rule are required to be true in some samples of the predictive class, but not all true in any samples of any classes other than the one in the predictive term.

The number in m conditions is preferred to be no more than 5. Ideally, rules with m=1, 2, or 3 are best for clinical diagnosis.

As an example, the following rule (Li et al (2003), Bioinformatics, 19, 71-78) contains two conditions on the gene expression profiles of childhood leukemia cells:
If the expression of 40454_at is ≧8280.25
and the expression of 41425_at is ≧6821.75,
then this sample is subtype E2A-PBX1.

This rule is not satisfied by any cells of any leukemia subtypes other than E2A-PBX1, while 100% of the samples in the E2A-PBX1 class each satisfy both of the two conditions on gene expression profiling. It is therefore useful for clinical diagnosis purposes.

The decision trees may be generated by any method known to the skilled artisan. The most convenient method is by using one of the many available software packages such as CART, C4.5, OC1, TreeAge, Albero, ERGO, ERGOV, TESS, and eBestMatch.

In a second aspect the present invention provides a method of identifying two or more rules useful in analysis of biological data, the method comprising the steps of

providing a training dataset having a plurality of features,

generating a first decision tree having one feature of the dataset as the root node,

obtaining one or more rules from the first decision tree,

generating one or more further decision trees having a feature of the dataset not previously used in other decision trees as the root node, and

obtaining one or more further rules from each one or more further decision trees,

wherein the training dataset remains substantially unchanged through the iterative construction of the decision tree.

It must be appreciated that the present methods are not concerned only with the generation of single decision trees. One form of the invention relies on the generation of more than one tree to provide a “committee” of trees. As a tree is a collection of rules where every leaf of the tree corresponds to a rule, multiple trees can contain many significant rules. The use of multiple trees breaks the single coverage constraint shown by methods of the prior art, and allows the same training data to be explained by many either significant or minor rules. The approach of the present invention is advantageous because the mutually exclusive rules in one decision tree cut off many interactions among features. The inventors have surprisingly discovered that multiple trees contain significant rules that can capture many interactions from different aspects. The multiple cross-supportive rules therefore strengthen the power of prediction.

The methods described herein differ fundamentally from the state-of-the-art committee methods such as bagging (Breiman, L (1996). Machine Learning, 24, 123-140) and boosting (Freund, Y., & Shapire, R. E. (1996). Machine Learning: Proceedings of the thirteenth National Conference (pp. 148-156)). Unlike the prior art methods, the present methods uses the original training data instead of bootstrapped, or pseudo, training data to construct a sequence of different decision trees. The rules obtained by using multiple decision trees in this manner reflect more precisely the nature of the original training data. By contrast, the rules produced by the bagging or boosting methods may not be correct when applied to the original data as they sometimes only approximate the true rules.

The skilled artisan will be able to decide by trial and error on an effective number of decision trees to be generated. In a preferred embodiment of the invention the method comprises generating about 20 decision trees

A feature of the present invention is that each decision tree in a committee of trees considers a greater number of features than the methods of the prior art. Preferably each of the two or more decision trees consider at least about 25% of all the features in the dataset. More preferably each of the two or more decision trees consider at least about 50% of all the features in the dataset. Still more preferably each of the two or more decision trees consider at least about 75% of all the features in the dataset.

In a highly preferred form of the invention each of the two or more decision trees considers substantially all the features in the dataset. In this form of the invention all original features are open for selection to form rules, so the method avoids the difficult classical problem of how many top-ranked features to be used for a classification model. It has been found that the significant rules often contain low-ranked features, and that these features are sometimes necessary for classifiers to achieve perfect accuracy. If ad-hoc numbers of only top-ranked features are used as traditionally, many significant rules are missed or inaccurate.

Preferably each of the two or more decision trees consider substantially the same features in the dataset. In an alternative form, the two or more decision trees consider substantially the same number of features in the dataset.

In a preferred embodiment of the invention the two or more trees are cascaded. A committee of multiple trees may be constructed using a cascading approach. First, all features are ranked into a list according to their gain ratio (Quinlan, J. R. (1993). C4.5: Programs for machine learning. San Mateo, CA: Morgan Kaufmann). Then the first tree is built using the top-ranked feature as the root node, the second tree using the second top-ranked feature as root node, and so on. In general, the kth tree is built using the kth top-ranked feature as root node.

It will be clear that a method of the present invention could provide a large number of rules, and only some of them significant. Accordingly a further step in the method may comprise comparing the accuracy of at least two resultant rules to obtain a significant rule. Of course, in order to do this the training dataset must include a validated outcome in order to determine the accuracy of any given rule. Preferably the rules are compared for accuracy by comparison with the training dataset. The resultant rules may also be compared for accuracy using a test dataset which has an independently validated result.

Preferably the comparison includes weighting of the rules according to the coverage of the dataset. A rule has a coverage, namely the percentage of the samples in a class satisfying the rule. Suppose a class consists of 100 positive samples and a rule is satisfied by 75 of them, then this rule's coverage is 75%. The skilled person will be most interested in significant rules. A significant rule is one with a large coverage, for example at least 50%.

Given a known or test sample for classification, the method may make the final decision by voting, in a weighted manner, the rules in the kth trees of the committee that the test sample satisfies. One way of assigning weights to the rules is according to their coverage in the original training data; that is, each rule is weighted by the maximal percentage of training samples in a class that satisfy this rule. This weighting method distinguishes between significant and minor rules, so that those rules all contribute in accordance to their proportional roles to the final voting.

In addition to being different from bagging and boosting, applicant's method also differs from another voting method called the randomized decision trees (Dietterich, T. G. (2000). Machine Learning, 40, 139-158). This algorithm is a modified version of the C4.5 learning algorithm in which the decision about which split to introduce at each internal node of the tree is randomized. With a different random choice, a new tree is then constructed. Twenty of the best splits (in terms of gain ratio) for a feature were considered to be the pool of random choices (Dietterich, T. G. (2000). Machine Learning, 40, 139-158). Every member of a committee of randomized frees constructed by this method always shares the same root node feature. The only difference between the members is at their internal nodes. In contrast, applicant's trees in a committee differs from one another not only at root node but also at internal features. Applicant's committees of trees have much larger potential for diversity than the randomized trees.

In carrying out the methods described herein it is often found that significant rules often contain low-ranked features. This is not seen in rules discovered by prior art methods. For example, Applicants have discovered a significant rule from a prostate disease data set that comprises expression profiles from 52 tumor cells and 50 normal cells (Singh et al (2002), Cancer Cell, 1, 203-209).
If 32598_at ≦29 and 33886 at ≧10 and
34950_at ≦5, then this is a tumor cell.

This rule is a significant rule with a coverage of 94% (49/52) in the tumor class. Considering the ranking positions of the three features defined in the above rule, gene 32598_at sits at the first position, while the other two genes are globally lower-ranked at 210th position (gene 33886_at) and 266th position (gene 34950 at) in the entire set of 12,600 genes.

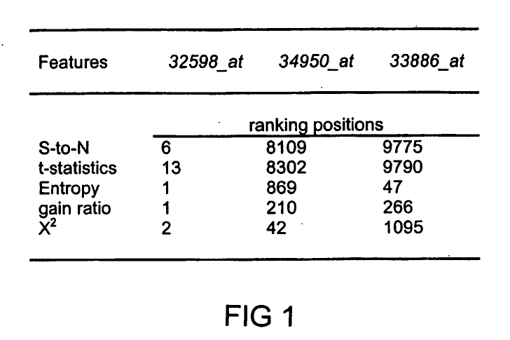

The rank order may be decided using a methods selected from the group including gain ratio, signal-to-noise measurement t-statistics, entropy, and X² measurement (Liu, H & Motoda, H (1998) Feature selection for knowledge discovery and data mining, Boston Mass.: Kluwer Academic Publishers). In fact, in order to verify that the advantages gained by the present methods are not an artifact of the ranking method used, alternative ranking in terms of metrics such as signal-to-noise measurement, t-statistics, and entropy and X² measurement were used. FIG. 1 shows the ranking positions of the three genes using various ranking methods. It was generally found that the ranking of the genes agrees even when different methods are used. Therefore, this example illustrates that even very low-ranked genes can be included in significant rules.

As a second example, Applicants present another significant rule, discovered from the same prostate cancer data set above, which is dominant in the normal class:
If 32598_at>29 and 40707_at>−6,
then this is a normal cell.

This rule is significant with an 82% (41/50) coverage in the normal class. The ranking positions of the two genes are as follows: gene 32598_at sits at the first position, while its component gene 40707_at is globally lower-ranked at a position below 1000th.

Preferably the features defining the root nodes of the decision tree are selected by ranking all features in the dataset according to their gain ratio or entropy. Given a data set pair having two classes of samples (positive or negative), a feature's discriminating power to differentiate the two classes can be roughly measured by its gain ratio (Quinlan, J. R. (1993). C4.5: Programs for machine learning. San Mateo, CA: Morgan Kaufmann), or by entropy (Fayyad, U & Irani, K. (1992). Machine Learning: Proceedings of the Thirteenth International Conference on Artificial Intelligence (pp. 104-110). AAAI Press). The entropy method measures the class distribution under a feature of the whole collection of samples. if the distribution—e.g., expression levels of a gene for x tumor and normal samples—shows clear boundary between the tumor and normal classes, this feature is then assigned a small entropy value. A small entropy value indicates a low or zero uncertainty for differentiating the two classes by this single feature, and such features are thus ranked at top positions.

Preferably the first tree is generated using the first top-ranked feature as the root node, the second tree is generated using the second top-ranked feature as the root node and so on. As described, committees of trees are constructed by forcing some top-ranked features iteratively as the root node of a new tree. There are also alternative ways to construct other types of tree committees that are in accordance with applicant's idea that the second could be the best.

In an alternative form of the invention a second level node can be selected on the basis of rankings. Suppose we allow k number of feature choices (usually top k features) for every node, then a committee of k trees can be built if the trees always have n nodes. If we allow k number of feature choices for nodes only at the first two levels (the root level and its immediate children level), we can get 27 trees when k=3. This approach focuses attention on top-ranked genes either globally at root node level or locally at children nodes' level.

In another alternative form of the invention reduced training data is used in subsequent trees by deleting one feature after building a previous tree. As an example of this approach, the first tree is constructed using the whole original data. The feature is then removed from the original data which was understood as the most important feature by C4.5. C4.5 was then applied to the reduced data to generate a second tree, and so on.

It is contemplated that the present methods could be combined with prior art methods to improve accuracy. For example, as C4.5 is a heuristic method, applicant's answer to discover all significant rules is still incomplete. On the other hand, the emerging pattern approach can solve the incompleteness problem if the data dimension is not that high. Combining the emerging pattern approach and the C4.5 heuristics, is likely to provide a closer approximation to the optimal answer.

Preferably the biological data or the training dataset is high-dimensional information. As used herein the term “high dimensional information” means information containing about 100 or more elements. The term “biological data” includes any information that may be obtained from an organism such as a mammal, reptile, insect, fish, plant, bacterium, yeast, virus, and the like. The information includes gene expression information such as transcription information or translation information. The information may also be mass spectrometry information such as size: charge ratios.

Preferably the biological data or the training dataset is obtained from a microarray instrument or a mass spectrometer.

It is contemplated that the method of the present invention may be embodied in the form of a computer executable program. The skilled person will be able to implement the methods described herein in one of a number of many programming languages known in the art. Such languages include, but are not limited to Fortran, Pascal, Ada, Cobol, C, C++, Eiffel, Visual C++, Visual Basic or any derivative of these. The program may be stored in a volatile form (for example, random access memory) or in a more permanent form such as a magnetic storage device (such as a hard drive) or on a CD-ROM.

In another aspect the present invention also provides a computer including a computer executable program described herein. The skilled person will understand that the selection of central processing unit will depend on the complexity of the simulation to be implemented. Preferably the central processing unit is selected from the group including Pentium 1, Pentium 2, Pentium 3, Pentium 4, Celeron, MIPS RISC R10000 or better.

In another aspect the present invention provides a rule or set of rules produced according to a method described herein.

In a further aspect the present invention provides a method of classifying, characterising, diagnosing or prognosing a disease in a patient comprising a method described herein.

In another aspect the present invention provides a method of identifying a biological process involved in a disease comprising a method described herein. Differentially expressed genes in a microarray experiment can be up-stream causal genes or can be merely down-stream surrogates. It will be noted that a surrogate gene's expression should be strongly correlated to a causal gene's and hence they should have similar discrimination power and should have similar ranking. Thus, if a significant rule contains both high-ranked and low-ranked genes, it would be suspected that these genes have independent paths of activation and thus there are at least two genes that are causal. This surprising finding has been observed in many other data sets such as a childhood leukemia data set (Yeoh, E-J., et al. (2002). Cancer Cell 1, 133-143.) a lung cancer data set on (Gordon et al, (2002). Cancer Research, 62, 4963-4967), an ovarian disease data set (Petricoin, E. F., et al., (2002) Lancet, 359, 572-577).

It will be understood that the present invention may be used to investigate diseases other than cancer. It is contemplated that any disease for which relevant biological data can be obtained could be used in the present invention

The invention will now be further described by reference to the following non-limiting examples.

### EXAMPLES

The following examples compare the performance of the methods of the present invention with prior art bagging and boosting methods, as well as support vector machines (SVM) (Burges (1998). Data Mining and Knowledge Discovery, 2, 121-167) and k-nearest neighbours on a wide array of expression data, including a childhood leukemia gene expression data (Yeoh, E-J., et al. (2002). Cancer Cell 1, 133-143.), an ovarian tumor proteomic data (Petricoin, E. F., et al., (2002) Lancet, 359, 572-577), a lung cancer gene expression data on (Gordon et al, (2002). Cancer Research, 62, 4963-4967), an ovarian disease data set (Petricoin, E. F., et al., (2002) Lancet, 359, 572-577), as well as other data (Armstrong et al., (2002), Nature Genetics, 30, 4147. All these data have been grouped in applicant's supplementary website http://sdmc.lit.org.sg/GEdatasets.

Results are reported based on two measures: test error numbers—the number of misclassifications on independent test samples, and the error numbers of 10-fold cross validation. When the error numbers are represented in the format x: y, it means that x number of samples from the first class and any number of samples from the second class are misclassified. The number of iterations used in bagging and boosting was set as 20—equal to the number of trees used in applicant's method. The main software package used in the experiments is We/ca version 3.2, its Java-written open source are available at http://www.cs.waikato.ac.nz/˜ml/weka/ under the GNU; General Public Licence.

### Example 1

### Classification of Ovarian Tumor and Normal Patients by Proteomics

Applicant's first evaluation is on a recent ovarian data set (Petricoin, E. F., et al., (2002) Lancet, 359, 572-577) which is about how to distinguish ovarian cancer from non-cancer using serum proteomic patterns (instead of DNA expression). This proteomic spectra data generated by mass spectroscopy can be found at http://clinicalproteomics.steem.com; there are several similar data sets in this site. The largest dataset (dated Jun. 19, 2002) was chosen for this example. The data has a total of 253 samples: 91 controls (non-cancer) and 162 ovarian cancers. Each data sample is described by 15,154 features, namely, the relative amplitudes of the intensities at 15,154 molecular mass/charge (M/Z) identities.

For each feature, all values (intensities) were normalized for the 253 samples using the following formula: NV=(V−Min)/(Max−Mm), where NV is the normalized value, V the raw value, Mm the minimum intensity and Max the maximum intensity of the given feature. The normalized data can be found at applicant's supplementary website: http://sdmc.lit.org.sg/GEdatasets.

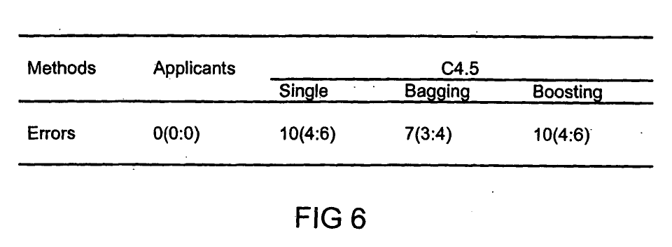

The original data set does not include a separate test data set. As such, applicant's method was evaluated using 10-fold cross validation over the whole data set. The performance is summarized in FIG. 6. It can be seen that method of the present invention is remarkably better than all the C4.5 family algorithms, reducing their 10 or 7 mistakes to a error-free performance in the total 253 test samples, giving rise to truly excellent diagnosis accuracy for ovarian cancer based on serum proteomic data.

For further comparison, SVM and 3-nearest neighbour were also used to conduct the same 10-fold cross validation. SVM also achieved 100% accuracy. However, SYM used all the 15,154 input features together with 40 support vectors and 8,308 kernel evaluations in its decisions. It is difficult to derive understandable explanations of any diagnostic decision made by this system. In contrast, applicant's method used only 20 trees and less than 100 rules. The other non-linear classifier, 3-nearest neighbour, have made 15 mistakes

What are the results if ad hoc numbers of only top-ranked features are used in the classification models? If only the top 10, 20, 25, 30, 35, or 40 entropy-ranked features are used, support vector machines could not achieve perfect accuracy; applicant's method could not achieve the perfect 100% accuracy either. All other classifiers such as k-nearest neighbour, C4.5 family algorithms, or naive bayes could not either. So, if the cut threshold were set as one of these ad-hoc numbers, the classification algorithms would miss the perfect accuracy on this data set, as applicant's algorithm and support vector machines can reach the 100% accuracy when the whole feature space are considered. In fact, some low-ranked features were used whose rankings were below the 3000th position. Such a comparison results indicate that some low-ranked features are necessary for classifiers to get perfect performance. Opening all features for consideration (though most of them may be not in the final rules) as used in applicant's method is an idea that is more flexible than the idea of using only top-ranked features.

### Example 2

### Subtype Classification of Childhood Leukemia by Gene Expression

Acute Lymphoblastic Leukemia (ALL) in children is a heterogeneous disease. The current technology to identify correct subtypes of leukemia is an imprecise and expensive process, requiring the combined expertise from many specialists who are not commonly available in a single medical center (Yeoh, E-J., et al. (2002). Cancer Cell 1, 133-143.). Using microarray gene expression technology and supervised classification algorithms, this problem can be solved such that the cost of diagnosis is reduced and at the same time the accuracy of both diagnosis and prognosis is increased.

Subtype classification of childhood leukemia has been comprehensively studied previously. The whole data consists of gene expression profiles of 327 ALL samples. These profiles were obtained by hybridization on the Affymetrix U95A GeneChip containing probes for 12558 genes. The data contain all the known acute lymphoblastic leukemia subtypes, including T-cell (T-ALL), E2A-PBX1, TEL-AML 1, BCR, ABL, MLL, and hyperdiploid (Hyperdip>50). The data were divided into a training set of 215 instances and an independent test set of 112 samples. There are 28, 18, 52, 9, 14, and 42 training instances and 15, 9, 27, 6, 6, and 22 test samples respectively for T-ALL, E2A-PBX1, TEL-AML1, BCRABL, MLL, and Hyperdip>50. There are also 52 training and 27 test samples of other miscellaneous subtypes.

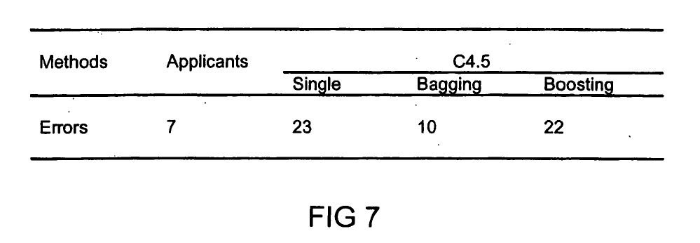

The original training and test data were layered in a tree-structure. The test error numbers of four classification models are presented, using the 6-level tree-structured data in, in FIG. 7. Applicant's test accuracy was shown to be much better than C4.5 and Boosting, and it was also superior to bagging. SVM made 23 mistakes on the same set of 112 test samples, while 3-nearest neighbour committed 22 mistakes. Their accuracy is therefore only around 80% (1—which is far below applicant's accuracy of 94%. Additionally, the SVM model is very complex, consisting of hundreds of kernel vectors and tens of thousands of kernel evaluations. In contrast, applicant's rules contained only 3 or 4 features, most of them with very high coverage; the rules are therefore easily understandable.

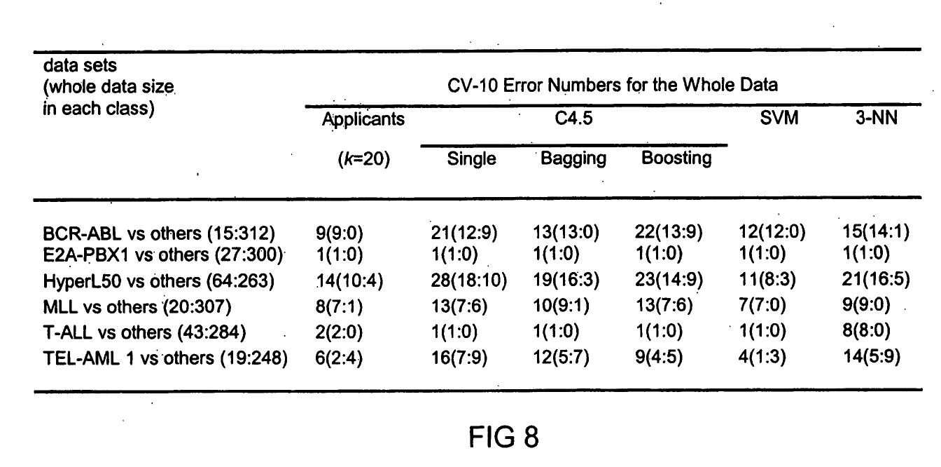

Results with 10-fold cross validations are also reported to see how well each subtype was distinguished from all other subtypes in the whole data set. The results are listed in FIG. 8. Again, applicant's method outperformed the C4.5 algorithm family and 3-nearest neighbour (3-NN), and had a comparable performance with SVM.

### Example 3

### Classification of Lung Cancer by Gene Expression

Gene expression method can also be used to classify lung cancer to potentially replace current cumbersome conventional methods to detect, for instance, the pathological distinction between malignant pleural mesothelioma (MPM) and adenocarcinoma (ADCA) of the lung. In fact, a recent study has used a ratio-based diagnosis to accurately differentiate between MPM and lung cancer in 181 tissue samples (31 MPM and 150 ADCA), suggesting that gene expression results can be useful in clinical diagnosis of lung cancer.

Note that in this case, the training set is fairly small, containing 32 samples (16 MPM and 16 ADCA), while the test set is relatively large, having 149 samples (15 MPM and 134 ADCA). Each sample is described by 12,533 features (genes). Results in comparison to those by the C4.5 family algorithms are shown in FIG. 9. Once again, applicant's results are better than C4.5 (single, bagging, and boosting).

### Example 4

### Results on Other Data Sets

The data sets studied so far are all more than one hundred samples. This example shows results using two relatively smaller data sets (Armstrong et al., (2002), Nature Genetics, 30, 4147) to ascertain see how the inventive methods fare with small data sets.

The first small data set from (Armstrong et al., (2002), Nature Genetics, 30, 41-47) is about the distinction between MLL and other conventional ALL subtypes. There are a total of only 573-class training samples (20, 17, and 20 respectively for ALL, MLL, and AML) and 15 test samples (4, 3, and 8 respectively for ALL, MLL, and AML). FIG. 10 (the second row) reports the respective classification performance. Once again, single C4.5 trees made several more mistakes than the other classifiers, while applicant's classifier displays outstanding excellence. SVM has similar results to applicant's, making no mistakes as well; but 3-nearest neighbour made 2 mistakes (1:1:0). For the widely-used ALL vs AML data set (Golub et al (1999), Science, 286, 531-537.) the performance is also reported in FIG. 10. In this instance, applicant's method made one more mistake than the C4.5 family algorithms on the 34 test samples. However, applicant's method was better than SVM (5 mistakes) and 3-NN (10 mistakes). On the other hand, for a comprehensive 10-fold cross-validation on the entire 72 samples, applicant's method was much better than the C4.5 family algorithms by making only 1 mistake (see the last row of FIG. 10). In this experiment, SVM made the same mistake as applicant's method. But k-nearest neighbour made 10 mistakes. If ad-hoc numbers (50, 100, or 200) of top-ranked features are pre-set and then used, no classifiers could achieve better performance than when all the original features are considered. Once again, this indicates that opening all original features for the selection of forming applicant's rules is advantageous.

### Example 5

### Down Change of Rules' Significance if Discovery is Based on a Small Number of Top-Ranked Features

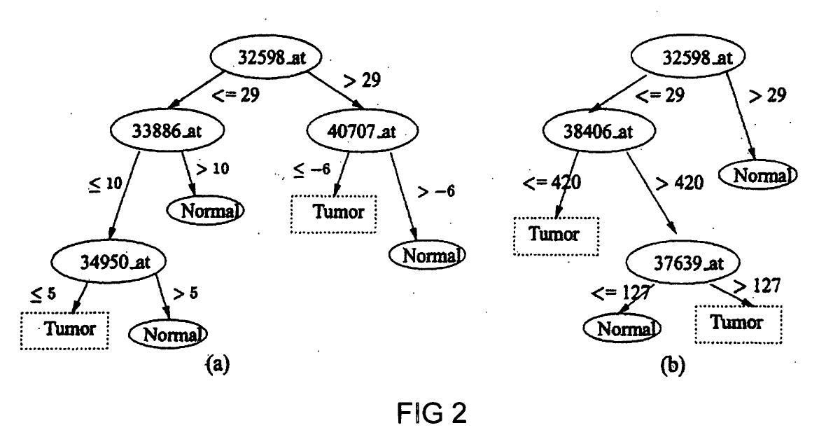

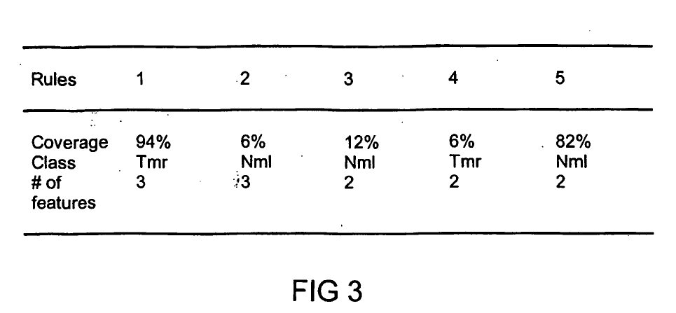

Here, C4.5 was used. (Quinlan, J. R. (1993). C4.5: Programs for machine learning. San Mateo, CA: Morgan Kaufmann) to build up two trees, namely two groups of rules, and then compare the rules to see if there are any changes. First, a tree is constructed based on the original whole feature space. The selection of tree nodes is freely open to any features, including globally low-ranked features. FIG. 2(a) shows the tree discovered from the prostate disease data set (Singh et al (2002), Cancer Cell, 1, 203-209). Each path of the tree, from root to a leaf, represents a single rule. So, this tree has five rules, obtained by the depth-first traversal to the five leaves. The rules are designated 1, 2, 3, 4 and 5 from the left side to right. Their respective coverage and number of features contained are listed in FIG. 3. Rule 1 is the most significant rule: it has a 94% coverage over the tumor class. Recall that this rule contains two extremely lower-ranked features as mentioned earlier.

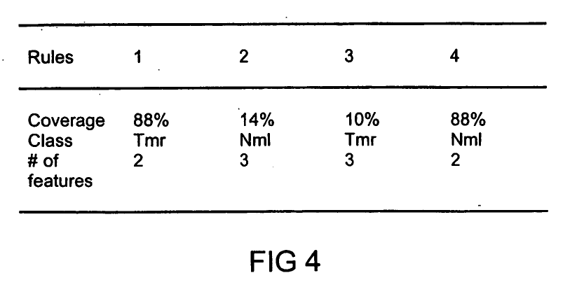

Next, the second tree to be constructed is limited to only 3 globally top-ranked features, namely 32598_at, 38406_at, and 37639_at. The number 3 was chosen to be equal to the number of features in the most significant rule (Rule 1) in the first tree. FIG. 2(b) shows the structure of the second tree; the rules' respective coverage and the number of features they contained are reported in FIG. 4.

An important observation is the unexpected decrease of the significance of top rule in the second tree constructed with only pre-filtered top-ranked features. This observation supports applicant's belief that the best could be the second best top-ranked feature groups do not necessarily produce the most important rules.

In fact, applicants have shown that if the lowest feature position in the most significant rule is p, then at least p number of top-ranked features are necessary for deriving a decision tree which can contain a rule with the same significance. It is hard to know the number p if the whole feature space is not considered. So, to pre-set a threshold to select top-ranked features is a heuristic that has a risk of losing useful low-ranked features.

### Example 6

### Alternative Trees can Perform Equally Well in Prediction

The aim of this example is to see if it is possible to generate, from the same training data set, two trees (or two groups of rules) that are diversified but perform equally well in prediction.

Given a data set, C4.5 was used to generate the “optimal” tree using the most discriminatory feature as the root node. Next, to generate an alternative tree, an approach that is slightly different from C4.5 was used: The second-best feature is forced to become the root node for this tree. The remaining nodes are then built by the standard C4.5 method. Applicants found that such pairs of trees often have almost the same prediction power, and sometimes, the second tree even outperforms the first one.

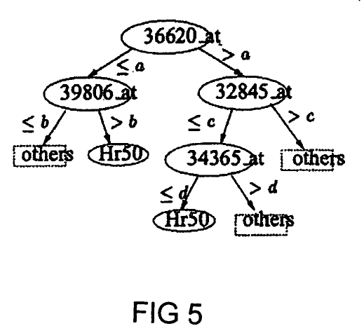

For illustration, an example is shown of a pair of trees where the so-called second-best tree actually greatly outperformed the first. FIG. 5 shows the “optimal” C4.5 tree constructed on a layered data set to differentiate the subtype Hyperdip>50 against other subtypes of childhood leukemia. Although this C4.5 tree made no mistakes on the training data, it made 13 errors out of 49 test samples. In this case, applicant's second-best tree managed to independently improve the dismal accuracy of the first tree by making only 9 mistakes on the testing set. Interestingly when the pair of trees are combined by applicant's method (shown in next section), the resulting hybrid made even fewer mistakes of only 6.

On closer inspection of this pair of trees, applicants found that the set of features used in the first tree is disjoint from the set used in the second tree. The former has the following four features at its tree nodes: 3662_at, 39806_at, 32845_at and 34365_at; but the latter has a different set of features at its four tree nodes: 38518_at, 32139_at, 35214_at and 40307_at. Therefore, the two trees are really diversified. The two trees each contain two significant rules each for one of the two classes. Again, these significant rules contain very low-ranked features such as 34365_at that sits at the 1878th position. Another particularly interesting point here is that the coverage of the top rules in the second tree has increased as compared to the rules in the first tree. This could explain why the second tree outperformed the first.

Yet another example can be found in trees constructed from the layered data set (Yeoh, E-J., et al. (2002). Cancer Cell 1, 133-143.) to differentiate the subtype MLL against other subtypes of childhood leukemia. Here, the first standard C4.5 tree made 1 mistake out of 55 test samples, while applicant's second tree made 2 mistakes. However, by combining the two trees, the hybrid made no mistakes with the test set. Randomly, ten such pairs of trees were examine and 4 pairs found where the first tree won, 3 pairs where the second tree won, and 3 pairs where the two trees got a tie in performance.

As applicant's tree pairs have generally similar prediction power, they can be treated as “experts” who understood the inherent inter-relationship of the features in the data with their own diversified experience. This suggests a committee of trees approach: It is possible to increase the diversity of the trees' “expertise” by generating a third tree, a fourth tree, and so on. The wide range of diversities provided by such a committee of trees or rules, together with the high quality of the individual trees in the committee, will provide a good basis for scientists to study bio-medical data and to conduct cancer diagnosis reliably.

### Example 7

### Rule Discovery

Given a training data set D having two classes of samples, positive and negative, the following steps were used to iteratively derive D trees from D, where D is significantly less than the number of features used in D. and usually D was set as 20:
Step 1: Use gain ratios to rank all the features into an ordered list with the best feature at the first position.
Step 2: i=1.
Step 3: Use the ith feature as root node to construct the ith tree.
Step 4: Increase i by 1 and go to Step 3, until i=k.

Then rules can be directly generated from these trees by the depth-first traversals. To identify significant rules, all the rules are ranked according to each rule's coverage, the top-ranked ones are significant. The significant rules may then be used for understanding possible interactions between the features (e.g., genes or proteins) involved in these rules. To use the rules for class prediction, applicant's method is described in the next subsection.

### Example 8

### Class Prediction

Given a test sample T, each of the k trees in the committee will have a specific rule to tell us a predicted class label for this test sample.

Denote the k rules from the tree committee as:
rule₁^{pos}, rule₂^{pos}, . . . , ruleₖ₁^{pos},
rule₁^{neg}, rule₂^{neg}, . . . , ruleₖ₂^{neg},

Here k₁+k₂=k. Each of rule₁^{pos} (1≦i≦k₁) predicts T to be in the positive class, while each of rulerᵢ^{neg} (1≦i≦k₂) predicts T to be in the negative class. Sometimes, the k predictions can be unanimous—i.e., either k₁=0 or k₂=0. In these situations, the predictions from all the k rules agree with one another, and the final decision is obvious and seemed reliable. Often, the k decisions are mixed with either a majority of positive classes or a majority of negative classes. In these situations, the following formulas were used to calculate two classification scores based on the coverages of these rules:

$${Score}^{pos} ( T ) = {\sum }_{i = 1}^{{k}_{1}} coverage ( {rule}_{i}^{pos} ) , \\ {Score}^{neg} ( T ) = {\sum }_{i = 1}^{{k}_{2}} coverage ( {rule}_{i}^{neg} ) .$$

If Score^{POS}(T) is larger than Score^{Neg}(T), the positive class is assigned to the test sample T. Otherwise, T is predicted as negative.

By using the rules' coverage as weights, the pitfalls of simple equal voting adopted by bagging (Breiman, L (1996). Machine Learning, 24, 123-140) are avoided. Applicant's weighting policy allows the tree committee to automatically distinguish the contributions from the minor rules and from the significant rules in the prediction process.

For multi-class problems, the classification score for a specific class, say class C, is calculated as:

$${Score}^{c} ( T ) = {\sum }_{i = 1}^{kc} coverage ( {rule}_{i}^{c} ) .$$

The class that receives the highest score is then predicted as the test sample's class.

Finally, it should be appreciated that many variations, modifications and alterations may be made to the above described composition without departing from the spirit or ambit of the invention.

1. A method of identifying a rule useful in the analysis of biological data, the method comprising providing a training dataset having a plurality of features, and generating a decision tree using the dataset, wherein the training dataset remains substantially unchanged through the iterative construction of the decision tree.

2. A method according to claim 1 wherein the number of features in the dataset are substantially unchanged throughout the process of generating the decision tree.

3. A method according to claim 1 wherein values of the features in the dataset are substantially unchanged throughout the process of generating the decision tree.

4. A method according to claim 1 wherein the features provide information on a gene.

5. A method according to claim 4 wherein the information relates to the expression level of the gene.

6. A method according to claim 1 wherein the decision tree is generated using a method embodied in a software package selected from the group consisting of CART, C4.5, OC1, TreeAge, Albero, ERGO, ERGOV, TESS, and eBestMatch.

7. A method according to claim 1 wherein the rule comprises one or more conditions with a predictive term.

8. A method according to claim 7 wherein the conditions are conjunctive.

9. A method according to claim 8 wherein the rule is:
If cond₁ and cond₂ and . . . condₘ,
then a predictive term

10. A method according to claim 7 wherein all conditions in a rule are required to be true in at least one sample of the predictive class.

11. A method according to claim 7 wherein not all conditions in a rule are required to be true in any sample of any classe other than the class in the predictive term.

12. A method according to claim 7 wherein the number of conditions in the rule is less than about 5.

13. A method according to claim 12 wherein the number of conditions is 1 or 2 or 3.

14. A method of identifying two or more rules useful in analysis of biological data, the method comprising providing a training dataset having a plurality of features, generating a first decision tree having one feature of the dataset as the root node, obtaining a rule from the first decision tree, generating one or more further decision trees having a feature of the dataset not previously used in other decision tree as the root node, and obtaining a further rule from each one or more further decision trees, wherein the training dataset remains substantially unchanged through the iterative construction of at least one decision tree.

15. A method according to claim 14 wherein the number of features in the dataset are substantially unchanged throughout the process of generating the decision tree.

16. A method according to claim 14 wherein values of the features in the dataset are substantially unchanged throughout the process of generating the decision tree.

17. A method according to claim 14 wherein the features provide information on a gene.

18. A method according to claim 17 wherein the information relates to the expression level of the gene.

19. A method according to claim 14 wherein the decision tree is generated using a method embodied in a software package selected from the group consisting of CART, C4.5, OC1, TreeAge, Albero, ERGO, ERGOV, TESS, and eBestMatch.

20. A method according to claim 14 wherein about 20 decision trees are generated.

21. A method according to claim 14 wherein the rule is a set of conditions with a predictive term.

22. A method according to claim 21 wherein the conditions are conjunctive.

23. A method according to claim 22 wherein the rule is:
If cond₁ and cond₂ and . . . condₘ,
then a predictive term

24. A method according to claim 21 wherein all conditions in a rule are required to be true in at least one sample of the predictive class.

25. A method according to claim 21 wherein not all conditions in a rule are required to be true in any sample of any class other than the class in the predictive term.

26. A method according to claim 21 wherein the number of conditions in the rule is less than about 5.

27. A method according to claim 26 wherein the number of conditions is 1 or 2 or 3.

28. A method according to claim 14 wherein each of the two or more decision trees consider at least about 25% of all the features in the dataset.

29. A method according to claim 28 wherein each of the two or more decision trees consider at least about 50% of all the features in the dataset.

30. A method according to claim 29 wherein each of the two or more decision trees consider at least about 75% of all the features in the dataset.

31. A method according to claim 30 wherein each of the two or more decision trees considers substantially all the features in the dataset.

32. A method according to claim 14 further comprising the step of comparing the accuracy of at least two resultant rules to obtain a significant rule.

33. A method according to claim 32 wherein the rules are compared for accuracy by comparison with the training dataset or by using a test dataset which has an independently validated result.

34. A method according to claim 33 wherein the comparison includes weighting of the rules according to the coverage of the dataset.

35. A method according to claim 32 wherein the significant rule contains a low-ranked feature.

36. A method according to claim 35 wherein the rank order of a feature is decided using a method selected from the group consisting of gain ratio, signal-to-noise measurement, t-statistics, entropy, and X² measurement.

37. A method according to claim 32 wherein the features defining the root nodes of the decision tree are selected by ranking all features in the dataset according to their gain ratio or entropy.

38. A method according to claim 14 wherein the first tree is generated using the first top-ranked feature as the root node, the second tree is generated using the second top-ranked feature as the root node etcetera.

39. A computer executable program capable of executing a method according to claim 1 or claim 14.

40. A rule or set of rules produced according to a method according to claim 1 or claim 14.

41. A method of classifying, characterising, diagnosing or prognosing a disease in a patient comprising a method according to claim 1 or claim 14.

42. A method of identifying a biological process involved in a disease comprising a method according to claim 1 or claim 14.

43. A method according to claim 41 wherein the disease is cancer.

44. A method according to claim 43 wherein the cancer is selected from the group consisting of prostate cancer, childhood leukemia, and ovarian cancer.

45. (canceled)

46. (canceled)

47. A method according to claim 42 wherein the disease is cancer.

48. A method according to claim 47 wherein the cancer is selected from the group consisting of prostate cancer, childhood leukemia, and ovarian cancer.
